(19) United States
(12) Patent Application Publication
(10) Pub. No.: US 2009/0042157 A1
(43) Pub. Date: Feb. 12, 2009

(54) Dual access kiln construction

(75) Inventor: Michael D. Kelly, Sand Point, MI (US)

Correspondence Address: JOHN MCCULLOCH, 5291 COLONY DRIVE NORTH,, STE. 1, SAGINAW, MI, 48638, US

(73) Assignee: EVENHEAT KILN, INC.

(21) Appl. No.: 11/890,351

(22) Filed: Aug. 6, 2007

(51) Int. Cl. F27D 1/18

(52) U.S. Cl. 432/250

(57) ABSTRACT

A kiln for use in producing ceramic ware comprises an endless wall forming a firing chamber supported on a base and a lid for closing and opening the upper end of the chamber. The body is movable from a position in which the chamber is closed by the base to a position in which the base is exposed. The lid is mounted for movement between positions in which it closes the upper end of the top of the chamber to a position in which the top is open. The body and the lid are movable between their respective positions independently of the other.

This invention relates to a kiln of the kind used in the production of ceramic objects and more particularly to a kiln having an endless wall forming an enclosure accessible selectively via the top or bottom thereof.

### BACKGROUND OF THE INVENTION

Kilns for the production of ceramics are well known. Some of such kilns have a body forming an enclosure that is accessible via a hinged lid or cover, whereas others of such kilns have a body which may be moved to a position in which the enclosure is accessible via the bottom thereof. Other kilns provide access into the interior of the enclosure via an opening in a side wall of the body.

There are some occasions when access to the interior of the body via an opening in the top is desirable, whereas there are other instances in which access to the interior of the enclosure via an opening in the bottom is desirable.

A principal object of the invention is to provide a kiln which enables access to the interior of the kiln body either through an opening in the top or an opening in the bottom, thereby enabling a single kiln to have a greater adaptability in the firing of ceramic ware.

### SUMMARY OF THE INVENTION

A kiln constructed in accordance with the preferred embodiment of the invention comprises a kiln body having walls forming a firing chamber in which ceramic ware may be accommodated and fired. The body has an open bottom which normally is supported on a base which, in use, provides support for the ceramic ware. The body also has an open top which, when the kiln is in use, is closed by a lid. Suitable heating elements are mounted within the kiln for producing heat required to fire the ceramic ware.

The construction includes a frame on which the base of the kiln is mounted. The frame also supports an upstanding bracket assembly which is external of and extends along one side of the body. The body is pivotally connected to the bracket assembly so as to be rockable from a first position, in which the chamber is closed at its bottom by the base, to an adjusted position in which the base is exposed so that ware may be supported on and removed from the base.

The body also includes a lid which is movable between positions in which the top of the chamber is either closed or open, thereby enabling ware to be introduced to and removed from the chamber through the open top of the latter. The lid also is connected to the bracket assembly for movements between the closed and open positions.

There are some instances in which the ware is better suited for introduction to and removal from a kiln firing chamber through the open top thereof, whereas there are other instances in which the ware is better introduced to and removed from the chamber via the open bottom thereof. In apparatus constructed in accordance with the invention, ware may be introduced into and removed from the kiln chamber either through the open top or through the open bottom. The body and the lid are movable between closed and open positions independently of one another.

### THE DRAWINGS

A kiln constructed in accordance with the disclosed embodiment is illustrated in the accompanying drawing wherein:

FIG. 1 is an isometric view illustrating a kiln having a lid movable between two positions in which it respectively closes and opens an access opening at the top of the kiln body;

FIG. 2 is as isometric view of the same kiln body occupying a position in which a firing chamber formed by the body is accessible through an open bottom;

FIG. 3 is a side elevational view of the kiln showing the kiln body, the kiln base, and the kiln lid in the positions they occupy when the kiln is in use;

FIG. 4 is a side elevational view of the kiln as shown in FIG. 3, but with the kiln body moved to a position in which the kiln base is exposed;

FIG. 5 is a side elevational view illustrating a kiln body supported on the kiln base and with the kiln lid in an open position;

FIG. 6 is a front elevational view illustrating the parts of the kiln in the positions they occupy when the kiln is in use; and

FIG. 7 is a rear elevational view showing parts of the kiln in the positions they occupy when the kiln is in condition for use.

### THE PREFERRED EMBODIMENT

A kiln constructed in accordance with the preferred embodiment of the invention is designated generally by the reference character 1 and comprises a pair of horizontal, spaced apart frame members 2 joined to one another by cross members 3. Supported on and spanning the frame members 2 is a base 4 which forms the bottom of a kiln body 5 having an endless, upstanding wall 6 forming a firing chamber 7 for the accommodation of ceramic ware (not shown). At the front of the body the wall 6 supports a handle 8. Within the chamber are heating elements 9 as is conventional.

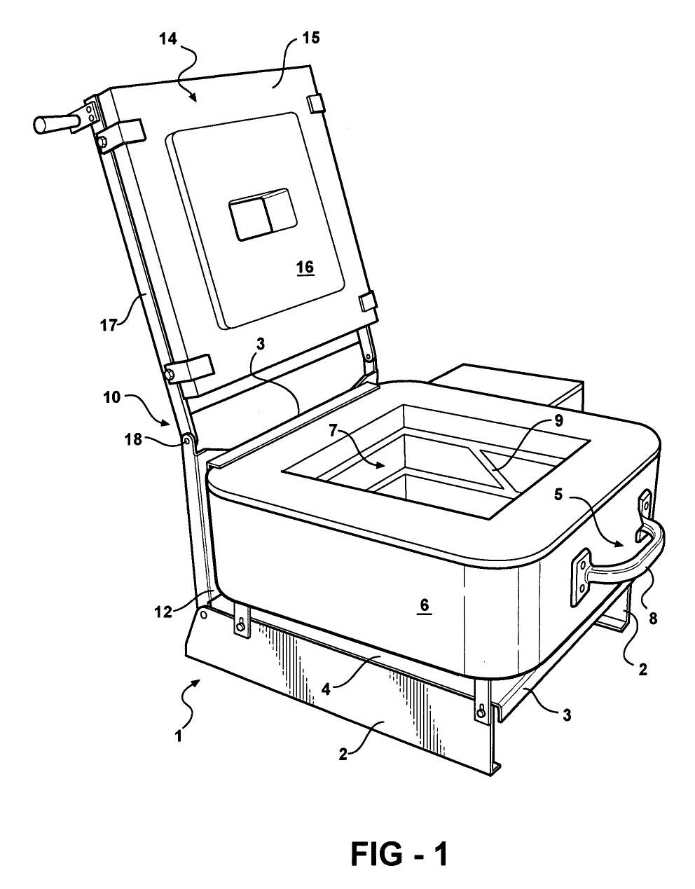

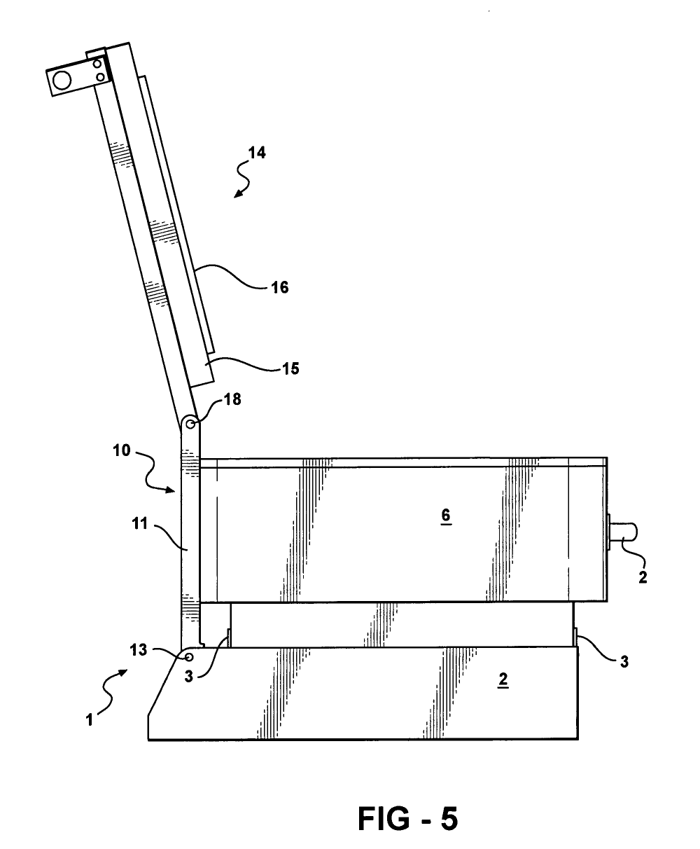

At the rear of the supporting frame 2 is mounted a common bracket assembly 10 comprising a pair of spaced apart legs 11 having flanges 12 which embrace and are secured to one side of the body 5. The bracket legs are rockably mounted on the support members 2 by pivot pins 13. The legs 11 of the bracket assembly are of such length as to extend both below and above the body 5, as is best shown in FIGS. 1, 3, and 5.

The kiln includes a lid or cover 14 having a peripheral surface 15 encircling a projection 16 which corresponds to the size and configuration of the top of the chamber 7. Overlying and secured to the lid is a pair of support arms 17 which, at their rearward ends, are pivoted by pivot pins 18 to the upper ends of the bracket arms 11. To one of the arms 17 is secured a support 19 on which is mounted a handle 20 which facilitates movements of the lid 14.

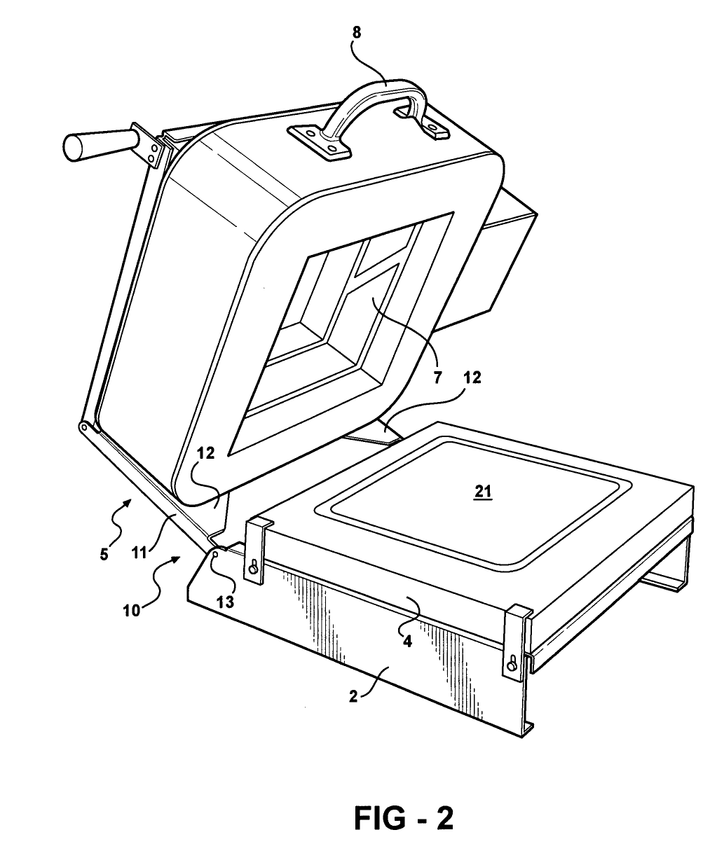

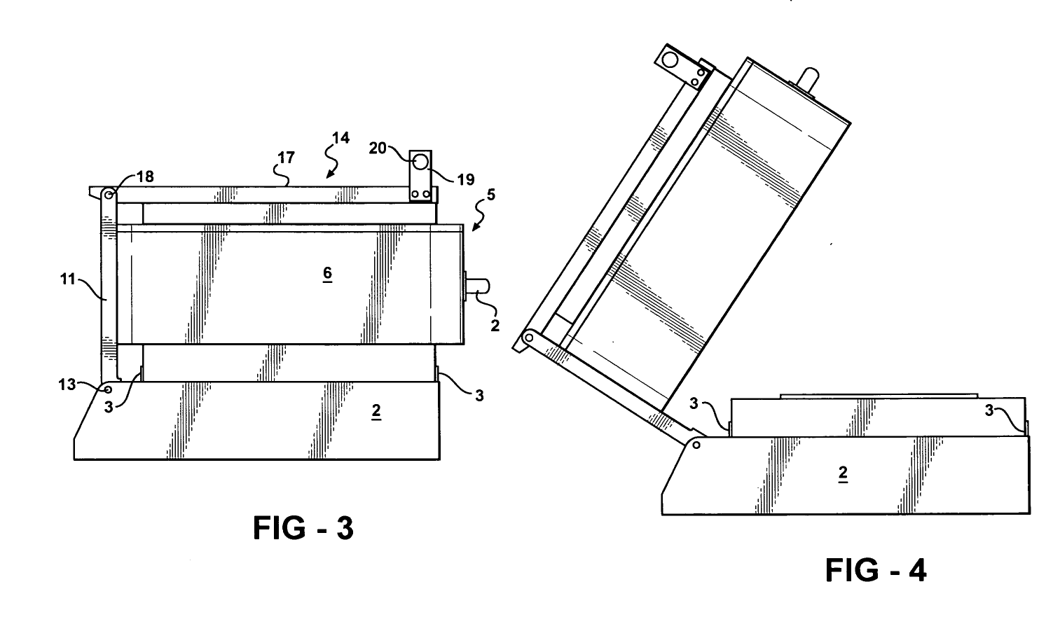

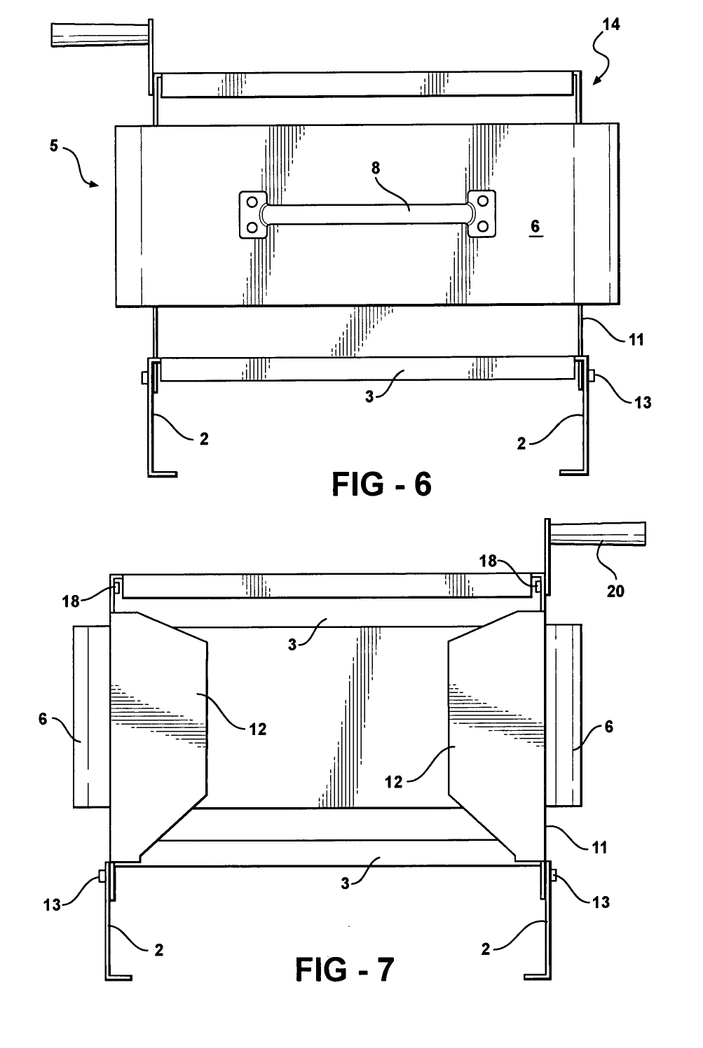

When the kiln is in condition for operation, the parts may occupy the positions as shown in FIGS. 3, 6, and 7 in which the firing chamber is closed at its bottom and top. Should it be desired to introduce or remove ceramic ware to or from the enclosure by moving the ware substantially horizontally, the lid 14 may remain closed and the body 5 rocked about the axes of the pivot pins 13 from the position shown in FIG. 3 to the position shown in FIG. 2. In these positions of the parts ware may be supported on or removed from the kiln base by movement of such ware substantially horizontally. The body may be returned to the closed position shown in FIG. 3 by means of the handle 8 thereby conditioning the kiln for use.

The base 4 has an upstanding projection 21 which corresponds in shape and area to the open bottom of the firing chamber. The projection is snugly accommodated within the enclosure to form a seal at the bottom of the chamber when the kiln is in use.

In those instances in which it is desired to place ware in or remove it from the kiln via the top, the lid 14 may be rocked about the axes of the pivot pins 18 from the position shown in FIG. 3 to the position shown in FIG. 1. In these positions the kiln chamber 7 may be accessed via the open top.

The projecting surface 16 of the lid corresponds to the shape and area of the upper open end of the chamber so that, when the lid is closed, the projection 16 will effect a seal at the upper end of the chamber.

Since the bracket assembly 10 is common to both the lid and the body, the lid may be moved between its chamber closed and opened positions independently of the movement of the kiln body, and the latter may be moved between its chamber closed and opened positions independently of the lid. The kiln, therefore, is easily adaptable to operating conditions wherein the ware is introduced and/or removed from the top of the kiln body or from the bottom thereof.

The kiln disclosed herein is one which enables the kiln firing chamber to be accessed from either the top or the bottom, as selected by the user. Although the kiln body is movable relative to the base and the lid is movable relative to the body, the parts of the construction always are joined so as to avoid having to disassemble and reassemble such parts.

The disclosed embodiment is representative of a presently preferred form of the invention, but is intended to be illustrative rather than definitive thereof. The invention is defined in the claims.

I claim:

1. A kiln construction comprising a kiln body forming a chamber having an open top and an open bottom; support bracket means external of said body and extending alongside thereof; a lid; lid mounting means mounting said lid for movements between first and second positions in which said lid respectively closes and opens said open top of said chamber; a base for supporting said body with said base closing said open bottom of said chamber; and body mounting means mounting said body for movements relative to said base between first and second positions in which said chamber is respectively accessible via said open bottom and closed by said base.

2. The construction according to claim 1 wherein said lid mounting means is pivotal.

3. The construction according to claim 1 wherein said body mounting means is pivotal.

4. The construction according to claim 1 wherein said lid mounting means includes an arm overlying and secured to said lid.

5. The construction according to claim 1 wherein said body mounting means includes leg means external of and said body.

6. The construction according to claim 1 wherein said lid and said body are pivotally mounted on said bracket means.

7. The construction according to claim 6 wherein said lid and said body are independently pivotal relative to one another.

8. A kiln construction comprising wall means forming a chamber having an open top and an open bottom; a lid; mounting bracket means; means mounting said lid on said bracket means for movements between respective first and second positions in which said lid closes and opens said top of said chamber; a base; and means mounting said body on said bracket means for movements between first and second respective positions in which said base closes and opens said bottom of said chamber; said lid and said body being movable between their said respective positions independently of one another.

9. The construction according to claim 8 wherein said lid mounting means is pivotal.

10. The construction according to claim 8 wherein said body mounting means is pivotal.

11. The construction according to claim 8 wherein said body has a selected height and wherein said bracket means is of such length as to extend beyond opposite ends of said body.

12. A kiln construction comprising a support frame; a hollow body forming a chamber having an open bottom and an open top; a base mounted on said frame for supporting said body and closing said open bottom; a lid for closing said open top of said body; support means carried by said frame external of said body and extending alongside the latter; body mounting means mounting said body on said frame for movements between respective first and second positions in which said chamber is non-accessible and accessible via said open bottom; and lid mounting means mounting said lid for movements between respective first and second positions in which said chamber is non-accessible and accessible via said open top, said body mounting means and said lid mounting means including common bracket means to which said body and said lid are connected.

13. The construction according to claim 12 wherein each of said body and said lid is pivotally connected to said bracket.

14. The construction according to claim 13 wherein said body is pivotal independently of said lid.
